(19) United States
(12) Patent Application Publication
(10) Pub. No.: US 2005/0136702 A1
(43) Pub. Date: Jun. 23, 2005

(54) Zero clearance power contact for processor power delivery

(76) Inventor: Joe A. Harrison, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/743,958

(22) Filed: Dec. 22, 2003

(51) Int. Cl. H01R 12/00

(52) U.S. Cl. 439/66

(57) ABSTRACT

A system for delivering power to a processor from a DC-to-DC converter. The system provides contacts, which are attached from underneath and located all around the die, that enable the system to provide three hundred and sixty degree power delivery capabilities to the processor from the power pod.

### BACKGROUND INFORMATION

In a typical computer system, a large printed circuit known as a “motherboard” contains a number of basic components. The motherboard is supplied with voltage from a power supply. The motherboard includes connectors for daughter boards that can be plugged in to provide additional capabilities. Such boards, for example, may provide an interface to disk drives and compact disk read only memories, and may provide modem interfaces for local area networks and the like.

Processors operate at lower voltages than some other components on the motherboard. However, because of their high speed, processors consume large amounts of power despite the fact that they use lower voltages. Since the processor is operating at a low voltage with high power, the current required by the processor is large. A localized DC-to-DC converter (also known as a voltage regulator module (VRM) or power pod) reduces the main supply voltage for supplying the processor, for example. Typically, for high current Intel 64 bit processors, the DC-to-DC converter connects directly to the processor package through an edge connector because of the high loss associated with conveying power through two connectors and the motherboard as in Intel 32 bit systems. The power connector may also provide signal connections related to power supply issues.

Intel 64 bit processors currently use card edge interconnects between the processor and the power pod for power delivery. This edge connector is located along one edge of a substrate with a connector and a housing. Contacts would then be loaded into the housing. However, with this limitation, power can be applied on only one edge.

The power is delivered in a coplanar application losing valuable real estate to “slide” the power pod assembly into the processor substrate to provide the interconnect. Furthermore, the current implementation makes Intel dependent upon interconnect suppliers for solution taking development time, dollars and outside resources. Therefore a need exists to have a substrate with the capability of having three hundred sixty degree processor power delivery.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a top view the present invention having edge connectors located around the die.

FIG. 2 is cross-sectional view of FIG. 1.

FIG. 3 is a cross-sectional view of an integrated power pod and power socket for power delivery.

FIGS. 4A and 4B illustrate contacts in uncompressed and compressed position for power delivery.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well know devices, circuits, and methods are omitted so as not to obscure the description of the present invention with unnecessary detail.

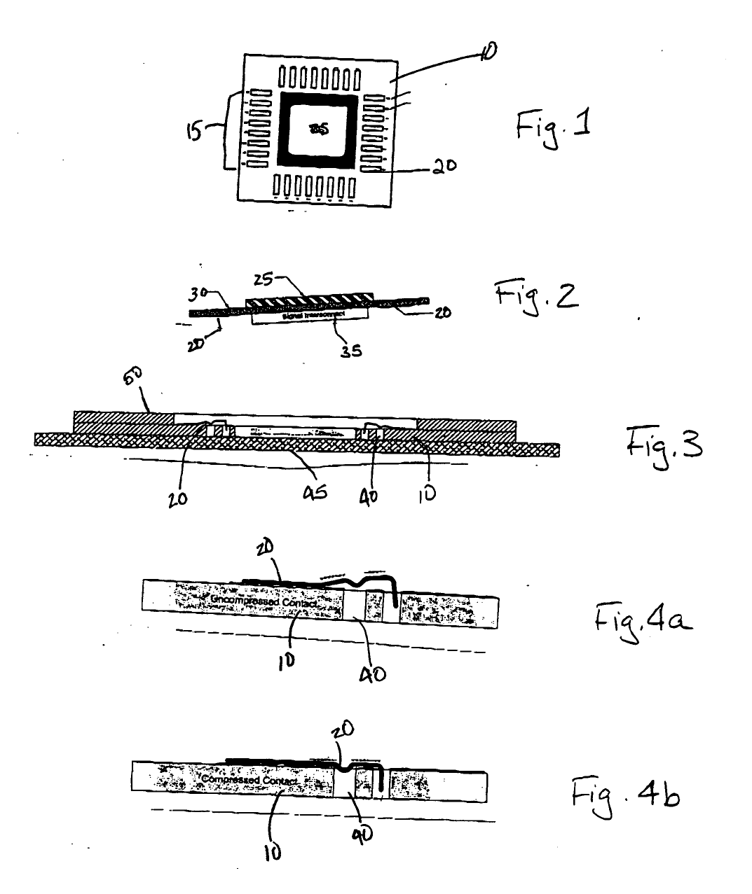

FIG. 1 is a top view of a substrate 10 having edge connectors 15. The edge connectors 15 have contacts 20 that enable communication around the circle of the die 25. The contacts 20 provide power and ground to the substrate 10. Typically, power is introduced on only one edge of the substrate. However, in the present invention, the edge connectors 15 can be placed anywhere on the substrate 10. This enables the contacts 20 to be in close proximity to the substrate 10 where the die 25 is located.

Advantageously, by having the contacts 20 close to the die 25 enables the user to have enhanced electrical characteristics and decreased interconnect parasitics. In addition, the current design allows for three hundred sixty degree power delivery on the substrate 10 surrounding the die 25 through an interposer 30.

FIG. 2 is a cross-sectional view of FIG. 1. As shown, the processor die 25 lies on top of the processor interposer 30. The contacts 20 are located at the bottom of the interposer 30 and attached from underneath. The contacts 20 may be made of copper and may be located on either side of a signal interconnect 35. The signal interconnect 35 is located below the interposer 30. The signal interconnect 35 can be any well known interconnect known in the art.

FIG. 3 illustrates a cross-sectional view of an integrated power pod and power socket for power delivery. The substrate 10 contains clearance holes or power socket 40 that enables a deflected contact 20 to protrude into the substrate 10 where it can be soldered. The substrate 10 lies on top of a motherboard 45 and a VRM 50 is located above the substrate 10. The current power contact design for zero clearance may be a surface mount contact. Having the edge connector 15 located around the die 25 enables the VRM 50 to have three hundred sixty degree power delivery capabilities to the processor.

FIGS. 4a and 4b illustrate zero clearance power contact for processor power delivery when uncompressed (FIG. 4a) and when compressed (FIG. 4b). Initially, as shown in FIG. 4a, the contact 20 lies on the substrate 10. However, when compression occurs, the processor interposer 30 pushes the contact 20 down into the VRM socket 40 (FIG. 4b). The compression is such that it creates the lowest vertical height possible to deliver power. Thus, the interposer 30 obtains the spring force needed to apply pressure to the processor die 25 and compresses the contacts 20 into the clearance holes 40 to enable them to deliver power.

Advantageously, the above design provides the lowest path for inductance and resistance and may be one element of a total compression solution. Furthermore, the design of having a bottoms up substrate power delivery allows re-use of existing probing in burn-in racks. Thus, enabling savings in millions of dollars in rework of existing test equipment.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

1. A device comprising:
a substrate;
an interposer on said substrate;
a DC-to-DC converter secured on said interposer; and
contacts located between the interposer and substrate, wherein said contacts are located all around a die on the substrate.

2. The device of claim 1, wherein the substrate contains power sockets.

3. The device of claim 2, wherein the contact compresses into the power sockets to provide electrical connection.

4. The device of claim 1, wherein said contacts are located underneath the interposer.

5. (canceled)

6. The device of claim 1, wherein the contacts are made of copper.
